(19) United States
(12) Patent Application Publication
(10) Pub. No.: US 2025/0020866 A1
(43) Pub. Date: Jan. 16, 2025

(54) OPTICAL FILTER, METHOD OF MANUFACTURING AN OPTICAL FILTER, METHOD OF DESIGNING, DESIGN APPARATUS, AND NON-TRANSITORY COMPUTER-READABLE RECORDING MEDIUM

(71) Applicants: Sumitomo Electric Industries, Ltd., Osaka-shi (JP); National University Corporation Hokkaido University, Sapporo-shi (JP)

(72) Inventors: Tsutomu Ishikawa, Osaka-shi (JP); Naoki Fujiwara, Osaka-shi (JP); Takeshi Fujisawa, Sapporo-shi (JP); Takanori Sato, Sapporo-shi (JP); Kunimasa Saitoh, Sapporo-shi (JP)

(73) Assignees: Sumitomo Electric Industries, Ltd., Osaka-shi (JP); National University Corporation Hokkaido University, Sapporo-shi (JP)

(21) Appl. No.: 18/746,690

(22) Filed: Jun. 18, 2024

(30) Foreign Application Priority Data
Jul. 10, 2023 (JP) 2023-113225

(51) Int. Cl. G02B 6/293; G02B 5/20; G02B 5/28; G02B 6/27

(52) U.S. Cl. CPC G02B 6/29353; G02B 5/207; G02B 5/28; G02B 6/2726

(57) ABSTRACT

It is an object to provide an optical filter, a method of manufacturing an optical filter, a method of designing, a design apparatus, and a program for designing non-transitory computer-readable recording medium which can suppress both the temperature dependency and the waveguide length. An optical filter includes three or more waveguides, and a plurality of sections provided in the three or more waveguides, respectively. Modes of light propagating through the sections of the three or more waveguides are different from each other.

### CROSS REFERENCE TO RELATED APPLICATIONS

This application claims priority based on Japanese Patent Application No. 2023-113225 filed on Jul. 10, 2023, and the entire contents of the Japanese patent application are incorporated herein by reference.

### TECHNICAL FIELD

The present disclosure relates to an optical filter, a method of manufacturing an optical filter, a method of designing, a design apparatus, and a non-transitory computer-readable recording medium.

### BACKGROUND

Silicon photonics in which an optical element is formed in silicon has been attracting attention. For example, a Mach-Zehnder interferometer may be formed in a silicon layer of a silicon on insulator (SOI) substrate. A TE0 mode and a TE1 mode are separately propagated through a plurality of waveguides of the Mach-Zehnder interferometer. A length, a width, and the like of the waveguide are adjusted according to the mode, thereby reducing the temperature dependency of a spectrum (non-patent document 1: “Broadband CMOS-compatible SOI temperature insensitive Mach-Zehnder interferometer” Peng Xing and Jaime Viegas OPTICS EXPRESS Vol. 23, No. 19 pp. 24098-24107 (2015)). A polarization rotator-splitters is provided on a silicon waveguide to convert the mode of light (non-patent document 2: “Polarization rotator-splitters in standard active silicon photonics platforms” Wesley D. Sacher et al. OPTICS EXPRESS Vol. 22, No. 4 pp. 3777-3786 (2014)).

### SUMMARY

An optical filter according to the present disclosure includes three or more waveguides, and a plurality of sections provided in the three or more waveguides, respectively. Modes of light propagating through the sections of the three or more waveguides are different from each other.

### BRIEF DESCRIPTION OF THE DRAWINGS

FIG. 1 is a plan view illustrating an optical filter according to an embodiment.

FIG. 2A is plan views illustrating waveguides.

FIG. 2B is a plan view illustrating a waveguide.

FIG. 2C is a plan view illustrating a waveguide.

FIG. 2D is a plan view illustrating a waveguide.

FIG. 3A is a cross-sectional view illustrating a waveguide.

FIG. 3B is a cross-sectional view illustrating a polarization rotator.

FIG. 4A is a diagram illustrating a transmission spectrum of an optical filter.

FIG. 4B is a diagram illustrating shift amounts.

FIG. 5A is a block diagram illustrating an optical filter design apparatus.

FIG. 5B is a block diagram illustrating a hardware configuration of a control unit.

FIG. 6A is a flow chart illustrating a method of manufacturing an optical filter.

FIG. 6B is a flow chart illustrating a method of manufacturing an optical filter.

FIG. 7A is a cross-sectional view illustrating a method of manufacturing an optical filter.

FIG. 7B is a cross-sectional view illustrating a method of manufacturing an optical filter.

FIG. 8 is a plan view illustrating an optical filter according to a comparative example.

FIG. 9 is a diagram illustrating calculation results of section lengths.

FIG. 10 is a diagram illustrating calculation results of section lengths.

FIG. 11 is a diagram illustrating calculation results of section lengths.

FIG. 12 is a diagram illustrating calculation results of section lengths.

FIG. 13A is a diagram illustrating an example of an approximate curve.

FIG. 13B is a diagram illustrating an example of an approximate curve.

FIG. 14A is a diagram illustrating a difference between section lengths.

FIG. 14B is a diagram illustrating a ratio of section lengths.

FIG. 15 is a diagram illustrating a wavelength locker.

FIG. 16 is a diagram illustrating transmittance.

### DETAILED DESCRIPTION

The length of the waveguide can be designed so that the temperature dependency is reduced by Eq. (9) of non-patent document 1. In order to miniaturize the optical filter, the waveguide is preferably short. The length of the waveguide depends on the width of the waveguide and FSR (Free Spectrum Range) indicating the interval of the peaks of a spectrum. As the width increases, the waveguide length increases. FSR and the length of the waveguide are in an inversely proportional relationship. When FSR is reduced, the waveguide is lengthened. That is, even if the temperature dependency is reduced, the waveguide may be lengthened. When the waveguide is long, an apparatus may be increased in size and propagation loss in the waveguide may increase. Therefore, it is an object to provide an optical filter, a method of manufacturing an optical filter, a method of designing, a design apparatus, and a non-transitory computer-readable recording medium which can suppress both the temperature dependency and the waveguide length.

### DESCRIPTION OF EMBODIMENTS OF PRESENT DISCLOSURE

First, the contents of embodiments of the present disclosure will be listed and explained.
(1) An optical filter according to an aspect of the present disclosure includes three or more waveguides, and a plurality of sections provided in the three or more waveguides, respectively. Modes of light propagating through the sections of the three or more waveguides are different from each other. By propagating three or more different modes, it is possible to suppress both the temperature dependency and the waveguide length.
(2) In the above (1), at least one of the three or more waveguides may have a polarization rotator. The polarization rotator converts the mode of light. By propagating three or more different modes, it is possible to suppress both the temperature dependency can be and the waveguide length.
(3) In the above (2), the three or more waveguides may include a waveguide core, and the polarization rotator may include the waveguide core and a rib portion protruding from the waveguide core. The phase of the light is changed in the polarization rotator. The length of the section is designed in consideration of the amount of change in phase. It is possible to suppress both the temperature dependency and the waveguide length.
(4) In the above (2) or (3), the three or more waveguides may include a first waveguide, a second waveguide, a third waveguide, and a fourth waveguide. The sections may include a first section, a second section, a third section, and a fourth section. The polarization rotator may include a first polarization rotator and a second polarization rotator. The first waveguide may be optically coupled to the second waveguide in a first coupling portion and is optically coupled to the third waveguide in a second coupling portion behind the first coupling portion, the first waveguide having the first section between the first coupling portion and the second coupling portion. The second waveguide may be optically coupled to the fourth waveguide in a third coupling portion behind the first coupling portion, the second waveguide having the second section between the first coupling portion and the third coupling portion. The third waveguide may be optically coupled to a portion of the fourth waveguide in front of the third coupling portion in a fourth coupling portion behind the second coupling portion, the third waveguide having the third section between the second coupling portion and the fourth coupling portion. The third waveguide may have the first polarization rotator and the second polarization rotator. The first polarization rotator may be located between the second coupling portion and the fourth coupling portion, the second polarization rotator may be located between the first polarization rotator and the fourth coupling portion. The third section may be located between the first polarization rotator and the second polarization rotator. The fourth waveguide may have the fourth section between the third coupling portion and the fourth coupling portion. A mode of light propagating through the first section and the fourth section, a mode of light propagating through the second section, and a mode of light propagating through the third section may be different from each other. Three modes propagate through the optical filter. It is possible to suppress both the temperature dependency and the waveguide length.
(5) In the above (4), a TE0 mode may propagate in the first section and the fourth section, a TE1 mode may propagate in the second section, and a TM0 mode may propagate in the third section. Three modes propagate through the optical filter. It is possible to suppress both the temperature dependency and the waveguide length.
(6) A method of manufacturing an optical filter, the optical filter including three or more waveguides, the three or more waveguides having a plurality of sections, respectively, modes of light propagating through the sections of the three or more waveguides being different from each other, each of the sections having a length corresponding to a propagation constant in a corresponding section and an amount of change in phase of light in the three or more waveguides. The method includes forming the three or more waveguides having the sections. It is possible to suppress both the temperature dependency and the waveguide length.
(7) In the above (6), the method may include designing the lengths of the sections, and forming the three or more waveguides based on the lengths of the sections. The designing of the lengths of the sections may include designing the lengths of the sections in accordance with equation 1:

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k}\end{matrix} ) ( \begin{matrix}L 1 \\ ⋮ \\ L n\end{matrix} ) = ( \begin{matrix}0 \\ 0 \\ \frac{{λ}^{2}}{FSR}\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k}\end{matrix} ) \qquad [ Equation 1 ]$$

where
   L1 to Ln denote the lengths of the sections,
   β1 to βn denote the propagation constants for the sections,
   T denotes a temperature,
   λ denotes a wavelength,
   k denotes a wave number,
   FSR denotes an interval between peaks of a spectrum, and
   φ denotes the amount of change in phase.
It is possible to suppress both the temperature dependency can and the waveguide length.
(8) In the above (7), the designing of the lengths of the sections may include determining widths of the sections to calculate terms of a matrix given in the equation 1. Width is determined to an appropriate size. The length of the section according to the width can be calculated. It is possible to suppress both the temperature dependency and the waveguide length.
(9) In the above (7) or (8), the three or more waveguides may include a first waveguide, a second waveguide, a third waveguide, and a fourth waveguide, the sections may include a first section, a second section, a third section, and a fourth section, the first waveguide may have the first section, the second waveguide may have the second section, the third waveguide may have the third section, the fourth waveguide may have the fourth section, a mode of light propagating through the first section and the fourth section, a mode of light propagating through the second section, and a mode of light propagating through the third section may be different from each other, and the designing of the lengths of the sections may design a total length of the first section and the fourth section, a length of the second section, and a length of the third section. By designing the lengths of the first section, the second section, the third section, and the fourth section, it is possible to suppress both the temperature dependency and the waveguide length.
(10) A method of designing an optical filter, the optical filter including three or more waveguides, the three or more waveguides having a plurality of sections, respectively, modes of light propagating through the sections of the three or more waveguides being different from each other. The method includes designing a length of each of the sections based on a propagation constant in a corresponding section and an amount of change in phase of light in the three or more waveguides. It is possible to suppress both the temperature dependency and the waveguide length.
(11) A design apparatus for designing an optical filter, the optical filter including three or more waveguides, the three or more waveguides having a plurality of sections, respectively, modes of light propagating through the sections of the three or more waveguides being different from each other, the design apparatus includes a first calculator configured to calculate propagation constants in the sections, a second calculator configured to calculate an amount of change in phase of light in the three or more waveguides, and a third calculator configured to calculate lengths of the sections, based on the propagation constants and the amount of change in phase. It is possible to suppress both the temperature dependency and the waveguide length.
(12) A non-transitory computer-readable recording medium having stored therein a program for designing an optical filter for causing a computer to execute a process, the optical filter including three or more waveguides, the three or more waveguides having a plurality of sections, respectively, modes of light propagating through the sections of the three or more waveguides being different from each other, the process including: calculating propagation constants in the sections, calculating an amount of change in phase of light in the three or more waveguides, and calculating lengths of the sections, based on the propagation constants and the amount of change in phase. It is possible to suppress both the temperature dependency and the waveguide length.

### DETAILS OF EMBODIMENTS OF PRESENT DISCLOSURE

Specific examples of an optical filter, a method of manufacturing an optical filter, a method of designing, a design apparatus, and a non-transitory computer-readable recording medium according to embodiments of the present disclosure will be described below with reference to the drawings. The present disclosure is not limited to these examples, but is defined by the scope of the claims, and is intended to include all modifications within the meaning and scope equivalent to the scope of the claims.

### Optical Filter

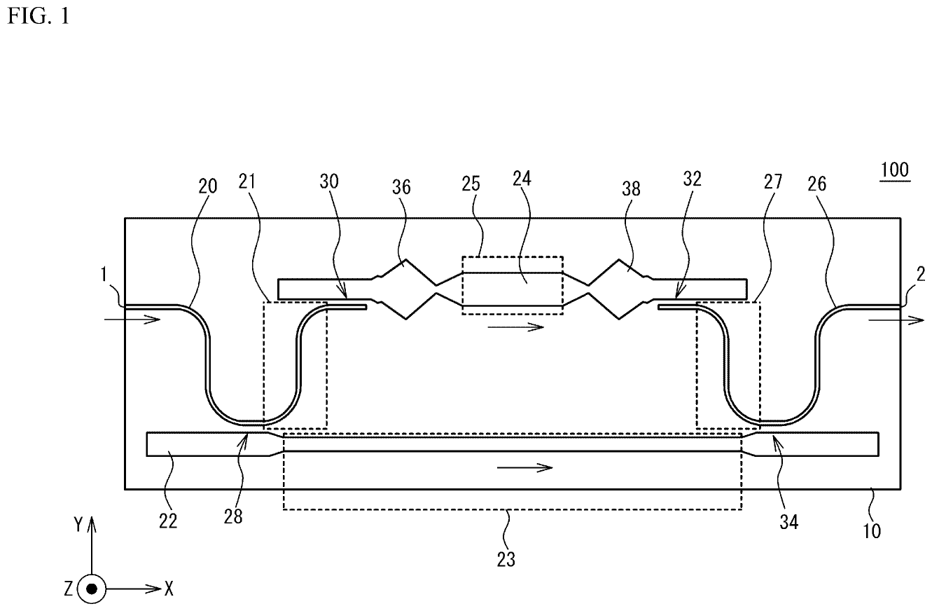

FIG. 1 is a plan view illustrating an optical filter 100 according to the embodiment. Optical filter 100 is a Mach-Zehnder interferometer filter and is formed on a substrate 10. Substrate 10 is, for example, a silicon on insulator (SOI) substrate. Two sides of substrate 10 are parallel to an X-axis direction. The other two sides are parallel to a Y-axis direction. The upper surface of substrate 10 is parallel to an XY plane. A Z-axis direction is a normal direction of substrate 10. The X-axis direction, the Y-axis direction, and the Z-axis direction are orthogonal to each other.

Optical filter 100 has a waveguide 20 (first waveguide), a waveguide 22 (second waveguide), a waveguide 24 (third waveguide), and a waveguide 26 (fourth waveguide). Waveguide 20 has a section 21 (first section). Waveguide 22 has a section 23 (second section). Waveguide 24 has a section 25 (third section). Waveguide 26 has a section 27 (fourth section). In FIG. 1, “section” is a portion surrounded by a dotted line.

Waveguide 20 has an entry port 1. Waveguide 26 has an exit port 2. Entry port 1 is located at one end of substrate 10. Exit port 2 is located at another end of substrate 10. Arrows in FIG. 1 represent light propagating through optical filter 100. The light incident on entry port 1 is demultiplexed into a plurality of waveguides, propagated, multiplexed, and emitted from exit port 2. The front side of the waveguide is closer to entry port 1, and the behind side thereof is closer to exit port 2 than the front side.

Waveguide 22 and waveguide 24 are parallel to the X-axis direction. Waveguide 22 and waveguide 24 are provided in the Y-axis direction. Waveguide 20 and waveguide 26 are located between waveguide 22 and waveguide 24.

Waveguide 20 and waveguide 22 form a directional coupler 28 (first coupling portion). In directional coupler 28, waveguide 20 and waveguide 22 are optically coupled. A portion of waveguide 20 behind directional coupler 28, and waveguide 24 form a directional coupler 30 (second coupling portion). In directional coupler 30, waveguide 20 and waveguide 24 are optically coupled.

A portion of waveguide 22 behind directional coupler 28, and waveguide 26 form a directional coupler 34 (third coupling portion). In directional coupler 34, waveguide 22 and waveguide 26 are optically coupled. A portion of waveguide 24 behind directional coupler 30 and a portion of waveguide 26 in front of directional coupler 34 form a directional coupler 32 (fourth coupling portion). In directional coupler 32, waveguide 24 and waveguide 26 are optically coupled. A coupler other than a directional coupler may be used as long as two waveguides are optically coupled.

A coupling length of directional coupler 30 and directional coupler 32 is longer than a coupling length of directional coupler 28 and directional coupler 34, for example, twice or more the coupling length of directional coupler 28 and directional coupler 34. The longer the coupling length, the higher the coupling coefficient, and the intensity of the transferred light increases. The shorter the coupling length, the lower the intensity of the transferred light. Coupling coefficients of directional coupler 30 and directional coupler 32 are higher than the coupling coefficients of directional coupler 28 and directional coupler 34.

Waveguide 24 has a polarization rotator 36 (first polarization rotator) and a polarization rotator 38 (second polarization rotator). Polarization rotator 36 is located between directional coupler 30 and directional coupler 32. Polarization rotator 38 is located between polarization rotator 36 and directional coupler 32. Section 25 is located between polarization rotator 36 and polarization rotator 38.

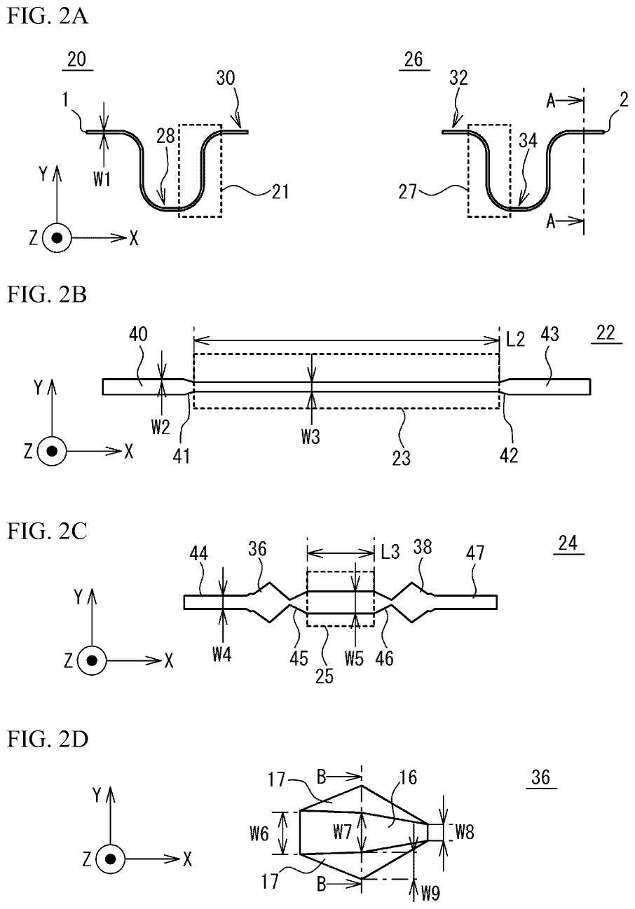

FIGS. 2A to 2D are plan views illustrating waveguides. FIG. 2A is plan views of waveguide 20 and waveguide 26. Waveguide 20 and waveguide 26 are curved. Widths W1 of waveguide 20 and waveguide 26 are constant, for example, 400 nm.

Section 21 of waveguide 20 is a portion between directional coupler 28 and directional coupler 30. Section 27 of waveguide 26 is a portion between directional coupler 32 and directional coupler 34. A length of section 21 is set to L1a. A length of section 27 is set to L1b. A total length of sections 21 and 27 is set to L1.

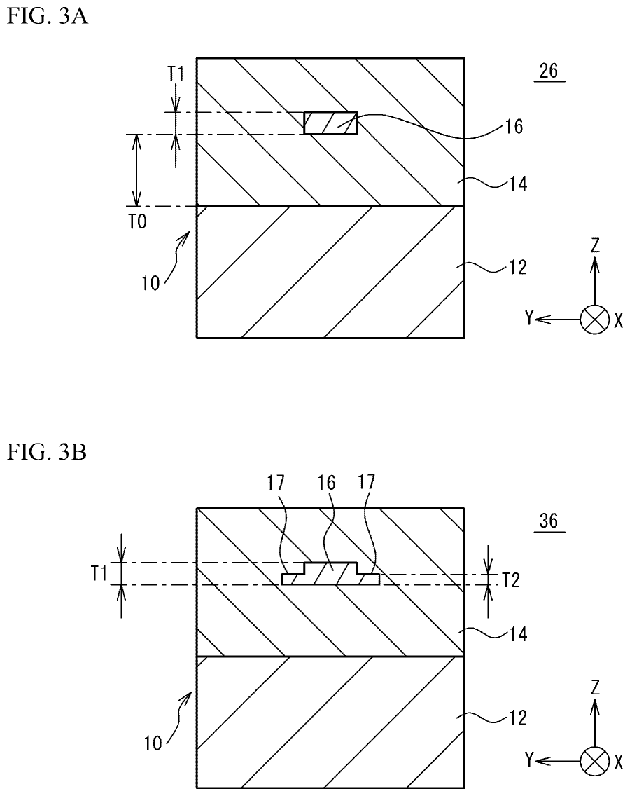

FIG. 3A is a cross-sectional view illustrating waveguide 26, illustrating a cross-section along line A-A of FIG. 2A. Substrate 10 has a substrate 12, a box layer 14, and a waveguide core 16. Substrate 12 and waveguide core 16 are formed of silicon (Si). Box layer 14 is formed of an insulating material such as silicon oxide (SiO₂). Box layer 14 is laminated on one surface of substrate 12. Waveguide core 16 is embedded in box layer 14 and functions as a waveguide. Waveguide core 16 is a part of a silicon layer. The silicon layer includes a terrace (not illustrated). Waveguide core 16 is spaced apart from the terrace. Thickness T1 of waveguide core 16 is, for example, 220 nm. Distance T0 between substrate 12 and waveguide core 16 is, for example, 2 μm.

FIG. 2B is a plan view of waveguide 22. Waveguide 22 has section 23, a section 40, a section 41, a section 42, and a section 43. Along the X-axis direction, section 40, section 41, section 23, section 42, and section 43 are arranged in this order. The cross section of waveguide 22 is the same as the cross section of waveguide 26 illustrated in FIG. 3A.

Directional coupler 28 illustrated in FIG. 1 is formed in section 40. Directional coupler 34 is formed in section 43. Widths W2 of sections 40 and 43 are larger than widths W1 of waveguide 20 and waveguide 26, and are, for example, 831 nm. The widths of sections 40 and 43 are constant.

Each of sections 41 and 42 has a tapered shape. A width of section 41 decreases from section 40 toward section 23. A width of section 42 increases from section 23 toward section 43. The widths of sections 41 and 42 vary, for example, from 831 nm to 660 nm.

Section 23 is a portion surrounded by a dotted line in FIG. 2B, and is located between section 41 and section 42. Width W3 of section 23 is larger than widths W1 of waveguide 20 and waveguide 26, smaller than widths W2 of sections 40 and 43, and, for example, 660 nm. Width W3 of section 23 is constant. A length of section 23 is set to L2.

FIG. 2C is a plan view of waveguide 24. Waveguide 24 has a section 44, polarization rotator 36, a section 45, section 25, a section 46, polarization rotator 38, and a section 47. In the X-axis direction, section 44, polarization rotator 36, section 45, section 25, section 46, polarization rotator 38, and section 47 are arranged in this order.

Widths W4 of sections 44 and 47 are larger than widths WI of waveguide 20 and waveguide 26, and are, for example, 831 nm. A width of section 44 is, for example, 880 nm in the vicinity of polarization rotator 36. A width of section 47 is, for example, 880 nm in the vicinity of polarization rotator 38.

Each of sections 45 and 46 has a tapered shape. A width of section 45 increases from polarization rotator 36 toward section 25. A width of section 46 decreases from section 25 toward polarization rotator 38. The widths of sections 45 and 46 vary, for example, from 500 nm to 1200 nm.

Section 25 is a portion surrounded by the dotted line in FIG. 2C. Width W5 of section 25 is constant, larger than widths W4 of sections 44 and 47 and widths W1 of waveguides 20 and 26, and, for example, 1200 nm. A length of section 25 is set to L3. The cross sections of waveguide 24 at sections 44, 45, 25, 46 and 47 are the same as the cross sections of waveguide 26 in FIG. 3A.

FIG. 2D is a plan view illustrating polarization rotator 36. FIG. 3B is a cross-sectional view illustrating polarization rotator 36, illustrating a cross-section along line B-B of FIG. 2D. Polarization rotator 38 has the same configuration as polarization rotator 36.

The planar shape of polarization rotator 36 is a tapered shape. Polarization rotator 36 includes waveguide core 16 and two rib portions 17. Waveguide core 16 is located in the center of polarization rotator 36. Rib portion 17 protrudes from waveguide core 16 to both sides in the Y-axis direction.

Width W6 at one end of waveguide core 16 is, for example, 880 nm. Width W7 in the center portion of waveguide core 16 is, for example, 700 nm. Width W8 at the other end of waveguide core 16 is, for example, 500 nm. Width W9 at the center of rib portion 17 is, for example, 500 nm. The line B-B in FIG. 2D is located at the center of rib portion 17 in the X-axis direction. A length of rib portion 17 in the X-axis direction is, for example, 100 μm.

As illustrated in FIG. 3B, waveguide core 16 and rib portion 17 are formed of a silicon layer. Thickness T2 of rib portion 17 is smaller than thickness T1 of waveguide core 16, and is, for example, 60 nm.

As illustrated in FIG. 1, light is incident on entry port 1. The mode of the incident light is the TE0 mode. The incident light propagates through waveguide 20. In directional coupler 28, a part of the light is transferred to waveguide 22. For example, 50% of the light may be transferred to waveguide 22, and 50% of the light may propagate in the portion of waveguide 20 behind directional coupler 28. That is, the ratio of the intensity of the light continuing to propagate through waveguide 20 to the intensity of the light transferred to waveguide 22 is, for example, 1:1.

In directional coupler 28, mode conversion is performed together with optical transition. The mode of the light changes from the TE0 mode to the TE1 mode. The light of the TE1 mode propagates through section 23 of waveguide 22.

The light of the TE0 mode propagates through section 21 of waveguide 20 and is transferred to waveguide 24 in directional coupler 30. For example, 95% or more of the light may be transferred to waveguide 24, and 100% of the light may be transferred to waveguide 24. In directional coupler 30, the mode of the light is converted from the TE0 mode to the TE1 mode.

In polarization rotator 36, mode conversion is performed and the mode is converted from the TE1 mode to the TM0 mode. The light of TM0 mode propagates through section 25 of waveguide 24 and enters polarization rotator 38. In polarization rotator 38, mode conversion is performed and the mode is converted from the TM0 mode to the TE1 mode.

The light of the TE1 mode is transferred to waveguide 26 in directional coupler 32. For example, 95% or more of the light may be transferred to waveguide 26, and 100% of the light may be transferred to waveguide 26. In directional coupler 32, the mode of the light is converted from the TE1 mode to the TE0 mode. The light of the TE0 mode propagates through section 27 of waveguide 26.

The light that propagates through section 23 of waveguide 22 is transferred to waveguide 26 in directional coupler 34. For example, 50% of the light is transferred to waveguide 26. In directional coupler 34, the mode of the light is converted from the TE1 mode to the TE0 mode. The light of the TE0 mode propagates through waveguide 26 and is emitted from exit port 2.

As described above, optical filter 100 branches incident light of one mode (for example, the TE0 mode) into a plurality of waveguides, the light in different modes (the TE0 mode, the TE1 mode, the TM0 mode) propagates through optical filter 100, and emitted light of one mode (for example, the TE0 mode) emits from optical filter 100.

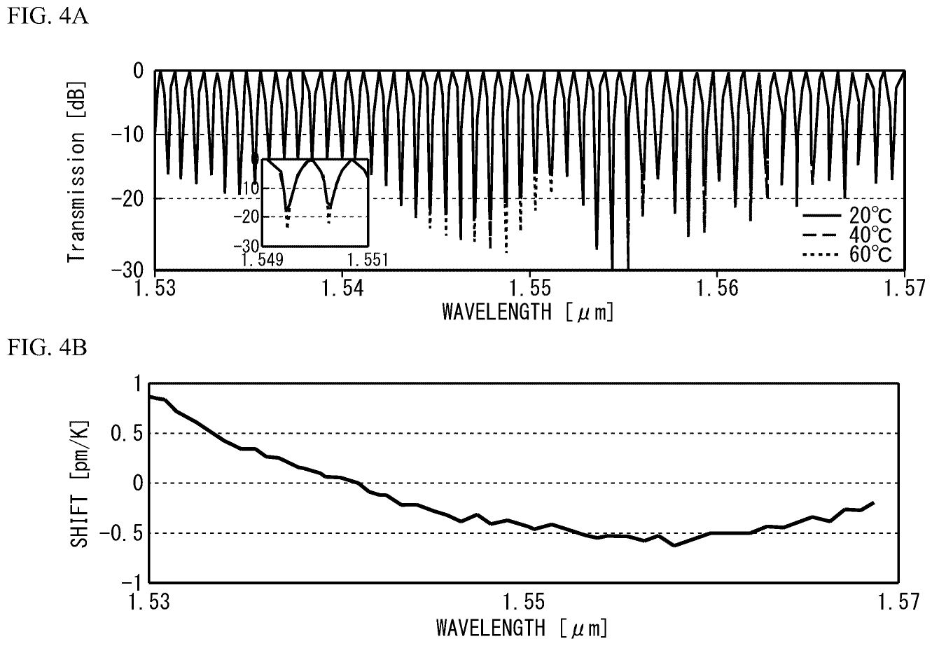

FIG. 4A is a diagram illustrating a transmission spectrum of optical filter 100. The horizontal axis represents the wavelength of light. The vertical axis represents the transmittance of optical filter 100. The spectrum is calculated with the temperature of optical filter 100 set to 20° C., 40° C., and 60°° C. The solid line represents the spectrum at 20° C. The dashed line represents the spectrum at 40° C. The dotted line represents the spectrum at 60° C. FSR is set to 0.8 nm. The values of width W1 to W9 are as described above. The lengths of the sections are set to optimum sizes by a method of designing described later.

As illustrated in FIG. 4A, the spectrum periodically shows peaks. As illustrated in the inset of FIG. 4A, the peaks of the spectrum at respective temperatures overlap. In other words, the shift of the peak is suppressed.

FIG. 4B is a diagram illustrating a shift amount. The horizontal axis represents wavelength. The vertical axis represents the shift amount of resonance peaks of the spectrum when the temperature is changed from 20° C. to 60° C. The shift amount is within ±1 pm. The amount of change in the peak position is small with respect to the temperature change. According to the embodiment, the temperature dependency of the spectrum may be suppressed to be low.

In order to suppress the temperature dependency as described above, the section length may be set to an appropriate size. The design of optical filter 100 will be described.

### Design Apparatus

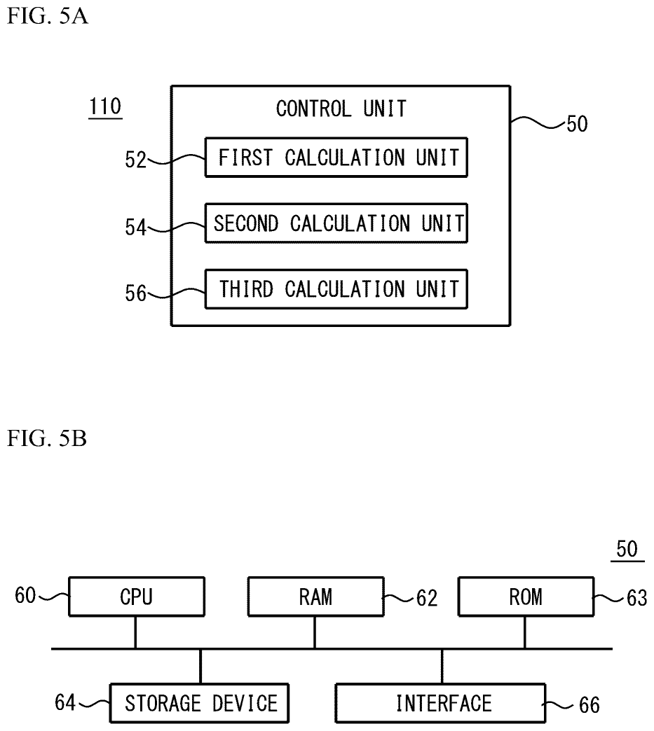

FIG. 5A is a block diagram illustrating a design apparatus 110 of optical filter 100. Design apparatus 110 designs the length of each of the sections of optical filter 100.

Design apparatus 110 has a control unit 50. Control unit 50 is a computer or the like, and functions as a first calculation unit 52, a second calculation unit 54, and a third calculation unit 56. The functions of the respective units of control unit 50 will be described later.

FIG. 5B is a block diagram illustrating a hardware configuration of control unit 50. As illustrated in FIG. 5B, control unit 50 includes a CPU (Central Processing Unit) 60, a RAM (Random Access Memory) 62, a ROM (Read Only Memory) 63, a storage device 64, and an interface 66. CPU 60, RAM 62, ROM 63, storage device 64, and interface 66 are connected to each other by a bus or the like. RAM 62 is a volatile memory for temporarily storing programs and data. Storage device 64 is a solid state drive (SSD) such as a flash memory, a hard disk drive (HHD), or the like. Storage device 64 stores programs and the like.

CPU 60 executes the program stored in RAM 62, whereby first calculation unit 52, second calculation unit 54, and third calculation unit 56 are achieved in control unit 50. Each unit of control unit 50 may be hardware such as a circuit.

### Calculation of Section Length

Design apparatus 110 designs the length of each of the sections of optical filter 100 in accordance with the following equation 2. A matrix on the left side of equation 2 may be referred to as matrix A. A column vector on the left side may be denoted by L. A first term on the right side may be described as B, and a second term may be described as C.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k}\end{matrix} ) ( \begin{matrix}L 1 \\ ⋮ \\ L n\end{matrix} ) = ( \begin{matrix}0 \\ 0 \\ \frac{{λ}^{2}}{FSR}\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k}\end{matrix} ) \qquad [ Equation 2 ]$$

In equation 2, β1 to βn are propagation constants of the sections. L1 to Ln are the lengths of the sections. The indices 1 to n in β and L are numbers corresponding to the sections. For example, β1 is a propagation constant in section 21 of waveguide 20 and section 27 of waveguide 26. L1 is the sum of the lengths of section 21 of waveguide 20 and section 27 of waveguide 26. T represents temperature of optical filter 100. λ is a wavelength of light propagating through optical filter 100. The symbol k is a wave number. FSR is an interval between adjacent peaks in the transmission spectrum of optical filter 100. φ is the sum of the amount of change in phase of the light.

The matrix A on the left side will be described. Each component of the first row of the matrix A is a partial derivative of the propagation constant with respect to the temperature T. Each component in the second row is a partial derivative of the propagation constant with respect to temperature T and the wavelength λ. Each component in the third row is a partial derivative of the propagation constant with respect to wave number k. The component of column vector L on the left side is the length of the section.

The first term on the right side is column vector B. The numerator of the third row of column vector B is the square of the wavelength λ. The denominator is FSR.

The second term on the right side is column vector C. The first row of column vector C is a partial derivative of the phase change amount o with respect to the temperature T. The second row is a partial derivative of the phase change amount q with respect to temperature T and the wavelength λ. The third row is a partial derivative of the phase change amount φ with respect to the wave number k.

The propagation constant is proportional to the refractive index of the section and depends on the width of the section. By determining the width of the section, the propagation constant is determined, and the matrix element of the matrix A is determined. The elements of column vector B are determined by the wavelength λ of the light propagating through optical filter 100 and the magnitude of FSR. The phase change amount φ depends on the shape of the waveguide, particularly the shape of the polarization rotator and the shape of the tapered portion such as section 41. The shape of the waveguide is determined, and thus the phase change amount φ is determined, and the components of column vector C are also determined.

As illustrated in FIG. 1, optical filter 100 has section 21, section 23, section 25, and section 27. The TE0 mode propagates through sections 21 and 27. The TE1 mode propagates through section 23. The TM0 mode propagates through section 25. In optical filter 100, the lengths of the sections corresponding to the three modes is calculated. That is, total length L1 of sections 21 and 27, length L2 of section 23, and length L3 of section 25 are calculated. By setting n=3 in equation 2, equation 3 is obtained. In equation 3, matrix A is 3×3 matrix. Column vectors L, B and C are each column vectors of three rows.

$$( \begin{matrix}\frac{\partial β 1}{\partial T} & \frac{\partial β 2}{\partial T} & \frac{\partial β 3}{\partial T} \\ \frac{{\partial }^{2} β 1}{\partial T \partial λ} & \frac{{\partial }^{2} β 2}{\partial T \partial λ} & \frac{{\partial }^{2} β 3}{\partial T \partial λ} \\ \frac{\partial β 1}{\partial k} & \frac{\partial β 2}{\partial k} & \frac{\partial β 3}{\partial k}\end{matrix} ) ( \begin{matrix}L 1 \\ L 2 \\ L 3\end{matrix} ) = ( \begin{matrix}0 \\ 0 \\ \frac{{λ}^{2}}{FSR}\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k}\end{matrix} ) \qquad [ Equation 3 ]$$

An example of the calculation is illustrated below. Widths W1 of sections 21 and 27 are set to 400 nm. Width W3 of section 23 is set to 660 nm. Width W5 of section 25 is set to 1200 nm. In this case, the matrix A is given by equation 4.

$$( \begin{matrix}\frac{\partial β 1}{\partial T} & \frac{\partial β 2}{\partial T} & \frac{\partial β 3}{\partial T} \\ \frac{{\partial }^{2} β 1}{\partial T \partial λ} & \frac{{\partial }^{2} β 2}{\partial T \partial λ} & \frac{{\partial }^{2} β 3}{\partial T \partial λ} \\ \frac{\partial β 1}{\partial k} & \frac{\partial β 2}{\partial k} & \frac{\partial β 3}{\partial k}\end{matrix} ) = ( \begin{matrix}7.95 \times {10}^{- 4} & 8.03 \times {10}^{- 4} & 5.57 \times {10}^{- 4} \\ - 7.95 \times {10}^{- 4} & - 1.63 \times {10}^{- 3} & - 1.41 \times {10}^{- 3} \\ 4.25 & 4.51 & 3.92\end{matrix} ) \qquad [ Equation 4 ]$$

In equation 4, the elements in the first row are 7.95×10⁻⁴ rad/μm/K, 8.03×10⁻⁴ rad/μm/K, and 5.57×10⁻⁴ rad/μm/K in order from the first column. The elements in the second row are −7.95×10⁻⁴ rad/μm²/K, −1.63×10⁻³ rad/μm²/K, and −1.41×10⁻³ rad/μm²/K. The elements in the third row are 4.25, 4.51, and 3.92.

The wavelength λ is set to 1550 nm, and FSR is set to 0.8 nm. As illustrated in equation 5, the element λ²/FSR of column vector B is 3003 μm.

$$B = ( \begin{matrix}\begin{matrix}0 \\ 0\end{matrix} \\ \frac{{λ}^{2}}{FSR}\end{matrix} ) = ( \begin{matrix}0 \\ 0 \\ 3003\end{matrix} ) \qquad [ Equation 5 ]$$

In equation 3, the lengths of each of the sections (section length) are calculated using the values of equations 4 and 5, with column vector C (second term on the right side) being zero. The calculation result of L is illustrated in equation 6.

$$L = ( \begin{matrix}\begin{matrix}L 1 \\ L 2\end{matrix} \\ L 3\end{matrix} ) = ( \begin{matrix}1.39 \\ - 4.24 \\ 4.12\end{matrix} ) \qquad [ Equation 6 ]$$

Length L1 is 1.39 mm, L2 is −4.24 mm, and L3 is 4.12 mm. In the calculation, the sign depends on the arrangement of the waveguide and can be positive or negative. In actual design and manufacture, the sign is positive.

Equation 7 is an example of column vector C which is the correction term.

$$C = ( \begin{matrix}\begin{matrix}\frac{\partial ϕ}{\partial T} \\ \frac{{\partial }^{2} ϕ}{\partial T \partial λ}\end{matrix} \\ \frac{\partial ϕ}{\partial k}\end{matrix} ) = ( \begin{matrix}\begin{matrix}- 7.3 \times {10}^{- 2} \\ 0.1 \times {10}^{- 1}\end{matrix} \\ - 402\end{matrix} ) \qquad [ Equation 7 ]$$

The elements in the first row are −7.3×10⁻² rad/K, 0.1×10⁻¹ rad/μm/K, and −402 μm in this order.

By solving equation 3 including column vector C of equation 7, a more accurate length of the section can be obtained. The calculation result of L is illustrated in equation 8.

$$L = ( \begin{matrix}\begin{matrix}L 1 \\ L 2\end{matrix} \\ L 3\end{matrix} ) = ( \begin{matrix}1.33 \\ - 4.26 \\ 4.12\end{matrix} ) \qquad [ Equation 8 ]$$

Length L1 is 1.33 mm, L2 is −4.26 mm, and L3 is 4.12 mm. A difference of about several tens of micrometers occurs between the section lengths of equations 6 and 8. The length of the section can be determined with high accuracy and the temperature dependency can be reduced by the effect of the correction term C.

### Method of Manufacturing

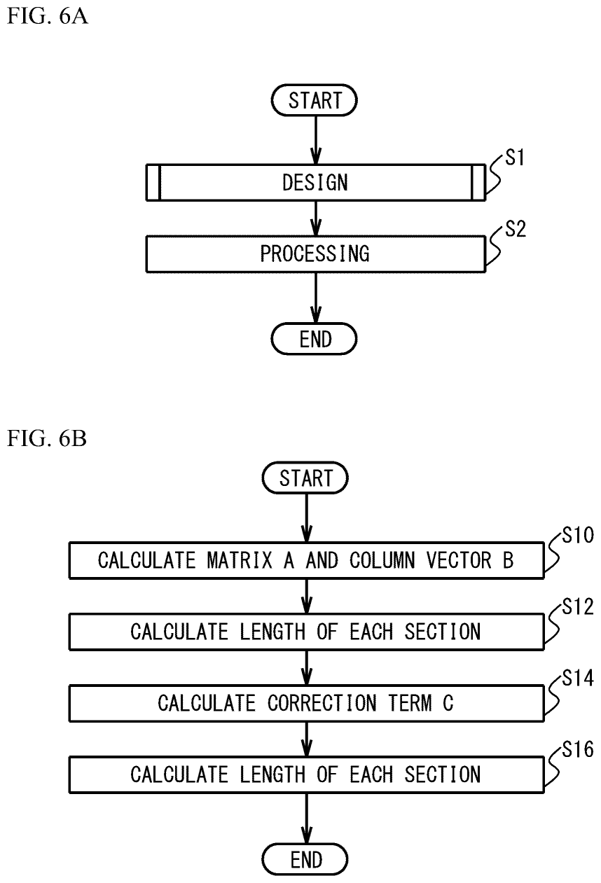

FIGS. 6A and 6B are flow charts illustrating a method of manufacturing optical filter 100. As illustrated in FIG. 6A, a design process is performed to design the length and the width of the waveguide (step S1). A wafer is processed to form a waveguide based on the design (step S2).

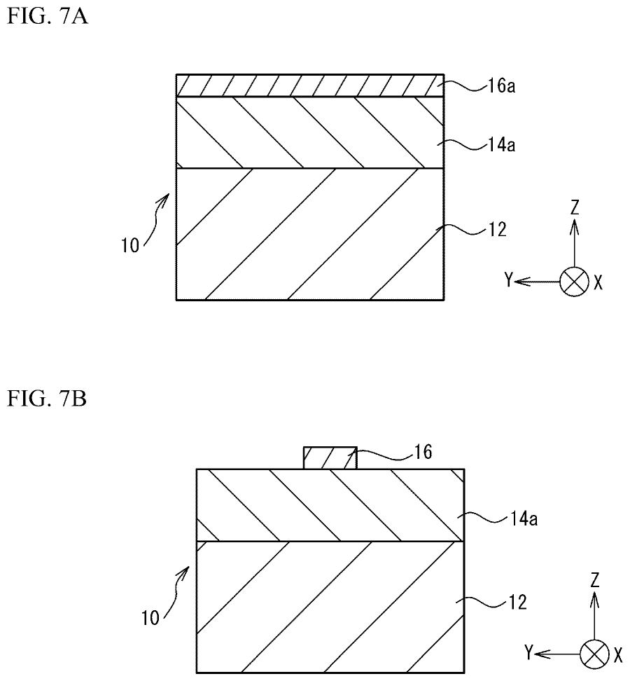

FIGS. 7A and 7B are cross-sectional views illustrating the method of manufacturing optical filter 100. As illustrated in FIG. 7A, a box layer 14a and a silicon layer 16a are sequentially laminated on one surface of substrate 12. A resist pattern (not illustrated) is provided on silicon layer 16a. As illustrated in FIG. 7B, silicon layer 16a is etched to form waveguide core 16 from silicon layer 16a. A box layer is further laminated on box layer 14a to form box layer 14. Optical filter 100 is formed by cutting the wafer.

As described above, waveguide core 16 is manufactured by etching silicon layer 16a. The thinner waveguide core 16, the more difficult it is to etch. The thicker waveguide core 16, the easier the etching and the easier the manufacture of waveguide core 16. The design is made taking into account such productivity as well as size and temperature dependencies.

FIG. 6B is a flow chart illustrating the design process, which corresponds to step S1 in FIG. 6A. First calculation unit 52 of control unit 50 calculates the matrix A and column vector B (step S10). First calculation unit 52 sweeps the width of the section and calculates the matrix element of the matrix A corresponding to each width. First calculation unit 52 calculates λ²/FSR of column vector B based on the wavelength of light and FSR.

Third calculation unit 56 calculates L1, L2, and L3 in column vector L using the matrix A and column vector B obtained in step S10 (step S12). At the time of step S12, calculation is performed without considering the correction term (column vector C), and lengths L1, L2, and L3 of the sections corresponding to the swept widths are calculated.

Second calculation unit 54 calculates the correction term (step S14). Third calculation unit 56 calculates the length of each of the sections in consideration of the correction term (step S16). In detail, appropriate values are selected from the widths and the section lengths obtained in step S12. When the width is large, the waveguide is easy to manufacture. As the section of the waveguide is shorter, the size of optical filter 100 can be suppressed. In order to achieve both high productivity and miniaturization, it is effective that the width is large and the section is short. Third calculation unit 56 selects a width and a section length suitable for such a request, and adds column vector C to the selected section length. That is, the section length is calculated using equation 2 (step S16). The process of FIG. 6B is then complete.

### COMPARATIVE EXAMPLE

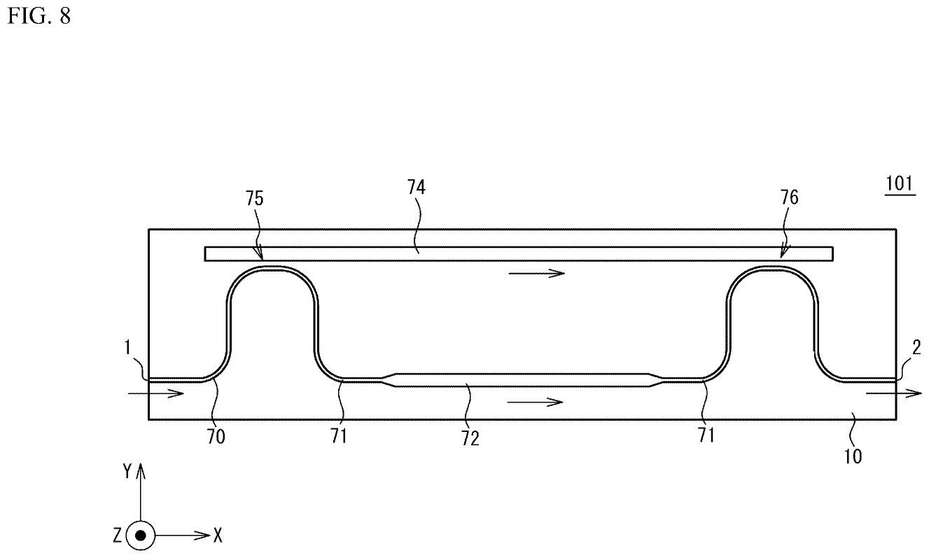

FIG. 8 is a plan view illustrating an optical filter 101 according to a comparative example. Optical filter 101 has a waveguide 70 and a waveguide 74. Waveguide 70 has a section 71 and a section 72. One of two sections 71 has entry port 1. The other of two sections 71 has exit port 2. Section 72 is provided between two sections 71. The width of section 72 is larger than that of section 71. A portion of waveguide 70 between section 71 and section 72 has a tapered shape.

One section 71 of waveguide 70 and waveguide 74 form a directional coupler 75. The other section 71 and waveguide 74 form a directional coupler 76.

The light of the TE0 mode enters from entry port 1 and propagates through waveguide 70. In directional coupler 75, a part of the light is transferred from waveguide 70 to waveguide 74. The mode of the light to be transferred changes from the TE0 mode to the TE1 mode. The light of the TE1 mode propagates through waveguide 74. The light of the TE0 mode propagates through section 72 of waveguide 70. In directional coupler 76, the light is transferred from waveguide 74 to waveguide 70. The mode of the light changes from the TE1 mode to the TE0 mode. The light of the TE0 mode propagates through waveguide 70 and is emitted from exit port 2.

Two modes propagate through optical filter 101 according to the comparative example. Three modes propagate optical filter 100 according to the embodiment. When the temperature dependencies of the characteristics of optical filter 100 and optical filter 101 are set to be substantially the same, the section length of optical filter 100 can be shorter than the section length of optical filter 101. That is, according to the embodiment, it is possible to suppress both the temperature dependency and the miniaturization. An example of the calculation result of the section length will be described below.

### Section Length

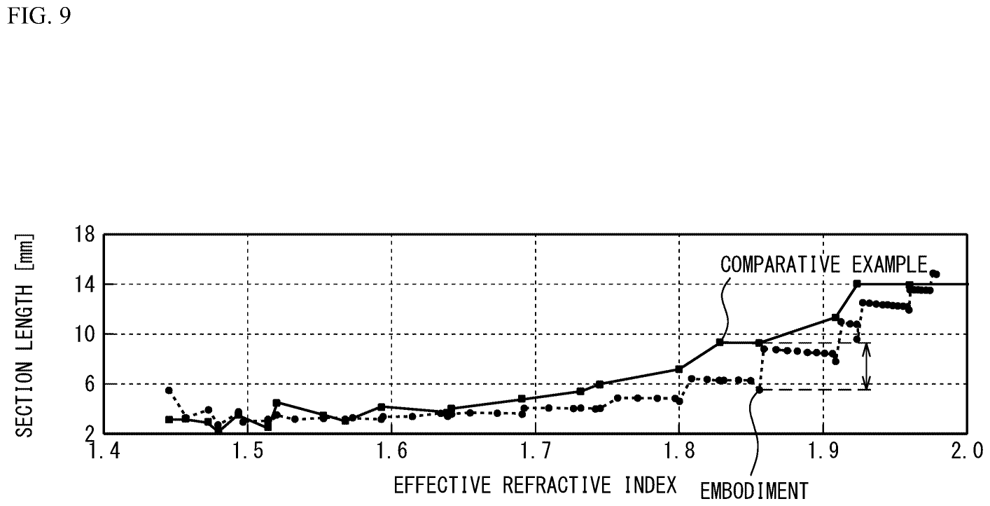

FIGS. 9 to 12 are diagrams illustrating calculation results of section lengths. The smaller the width of the waveguide, the lower the effective refractive index. The larger the width, the higher the effective refractive index. In the example of FIGS. 9 to 11, the width is swept and the length of the section is calculated using equation 3. Lengths L1, L2, and L3 of the sections are calculated for each effective refractive index. The horizontal axis of FIGS. 9 to 11 represents the minimum value of the effective refractive index of the plurality of sections. The vertical axis represents a maximum value among lengths L1, L2, and L3 of the plurality of sections.

In the example of FIG. 9, the width is swept from 150 nm to 1200 nm at 20 nm interval, and the length of the section is calculated using equation 3. The maximum values of lengths L1, L2 and L3 of the sections obtained for the respective refractive indices are plotted in FIG. 9. FSR is 0.8 nm, and the wavelength λ is 1550 nm.

The embodiment is indicated by a dotted line and black circles. Comparative examples is illustrated by solid lines and squares. The higher the refractive index, the longer the section length. The section length of the embodiment is shorter than the section length of the comparative example. For example, at a refractive index of about 1.85, the section length of the embodiment is about half of the section length of the comparative example.

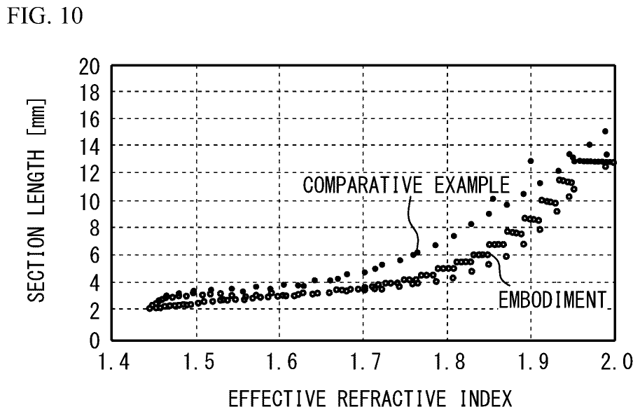

In the example of FIG. 10, the width is swept from 150 nm to 1600 nm at about 10 nm interval, and the section length for each refractive index is calculated. The black circle represents comparative example. The white circle represents the embodiment. The section length of the embodiment is shorter than the section length of the comparative example.

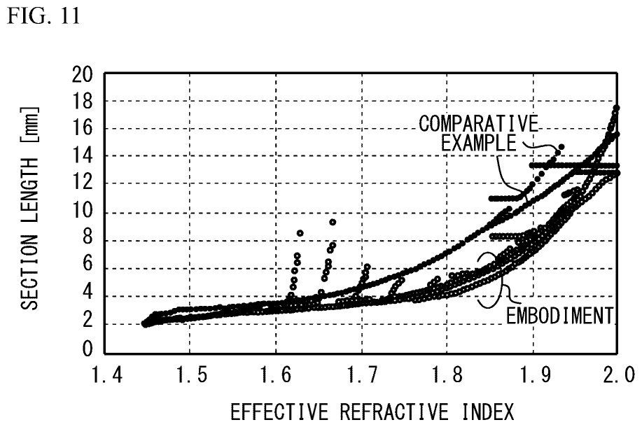

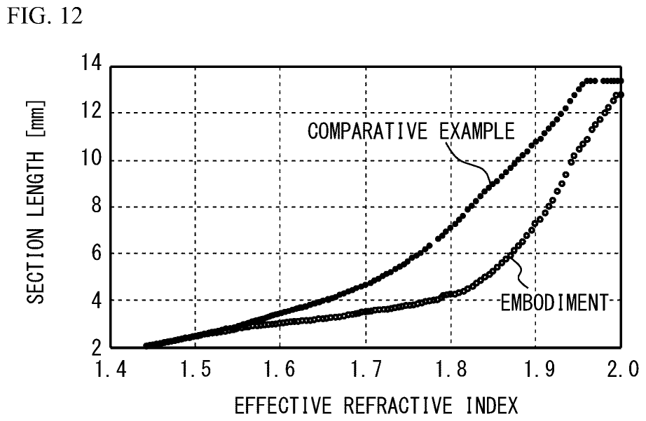

In the example of FIG. 11, the set of waveguide widths used in the example of FIG. 10 is swept in the range of ±10 nm at 1 nm interval. The black circle represents comparative example. The white circle represents the embodiment. Most of the section lengths in the embodiment are shorter than the section lengths in the comparative example. In FIG. 12, only the minimum values of the section lengths for each effective refractive index in FIG. 11 are plotted. The section length of the embodiment is shorter than the section length of the comparative example.

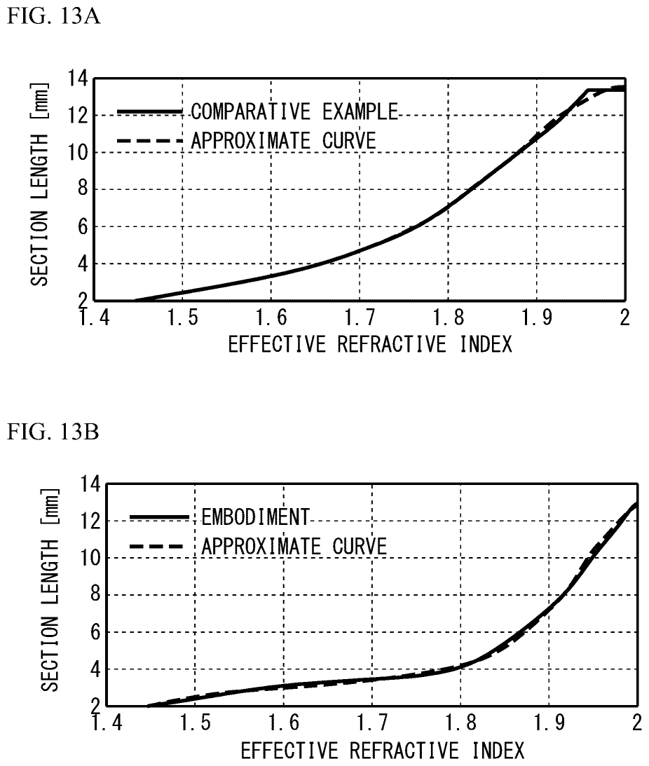

FIGS. 13A and 13B are examples of approximate curves. FIG. 13A illustrates an approximate curve of the comparative example of FIG. 12. FIG. 13B illustrates an approximate curve of the embodiment of FIG. 12. In FIGS. 13A and 13B, the solid line represents the calculation result. The dashed line represents the approximate curve.

The approximate curve in FIG. 13A is expressed by the following equation (1).

$$y = - 2000.8 {x}^{5} + 16725 {x}^{4} - 55699 {x}^{3} + 92423 {x}^{2} - 76428 x + 2 \; 5202 \qquad ( 1 )$$

The approximate curve in FIG. 13B is expressed by the following equation (2).

$$y = - 2192.6 {x}^{5} + 18972 {x}^{4} - 65282 {x}^{3} + 111720 {x}^{2} - 95112 x + 3 \; 2235 \qquad ( 2 )$$

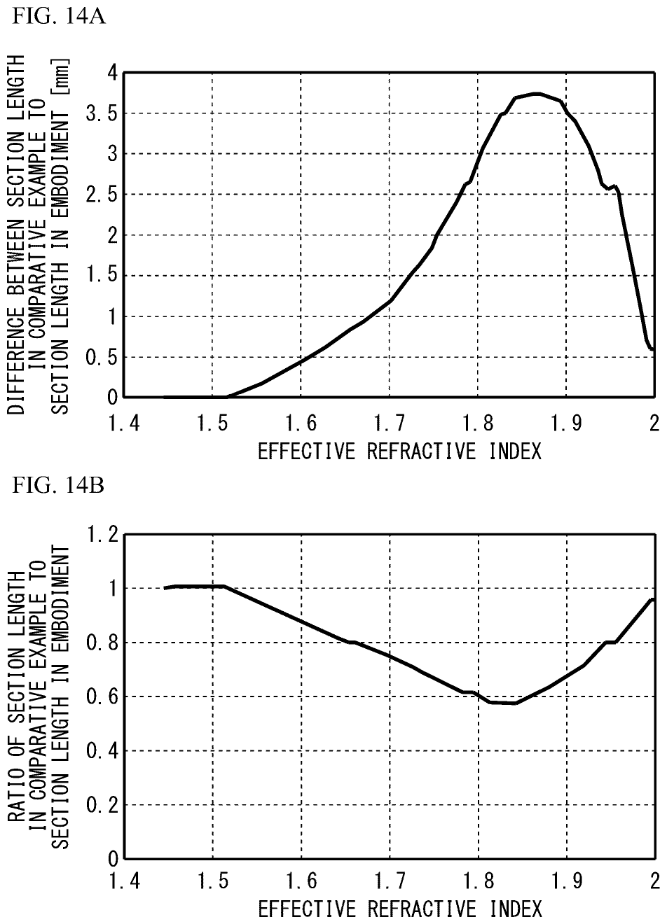

FIG. 14A is a diagram illustrating the difference between section lengths. The horizontal axis represents the effective refractive index. The vertical axis represents the difference between the section length in the comparative example and the section length in the embodiment in FIG. 12. Since the section length of the embodiment is shorter than the section length of the comparative example, the difference is a positive value. The difference is large in the range of the effective refractive index of 1.8 to 1.9, and is 2.5 mm or more.

FIG. 14B is a diagram illustrating a ratio of section lengths. The horizontal axis represents the effective refractive index. The vertical axis represents the ratio of the section length in the comparative example to the section length in the embodiment in FIG. 12. The ratio is 1 when the effective refractive index is in the range of about 1.45 to 1.5. In the range where the effective refractive index is larger than 1.5, the section length of the embodiment is shorter than the section length of the comparative example, and thus the ratio is less than 1. The ratio is the lowest value at an effective refractive index of about 1.8, and is about 0.6. That is, the section length of the embodiment is reduced to about 60% of that of the comparative example.

### Wavelength Locker

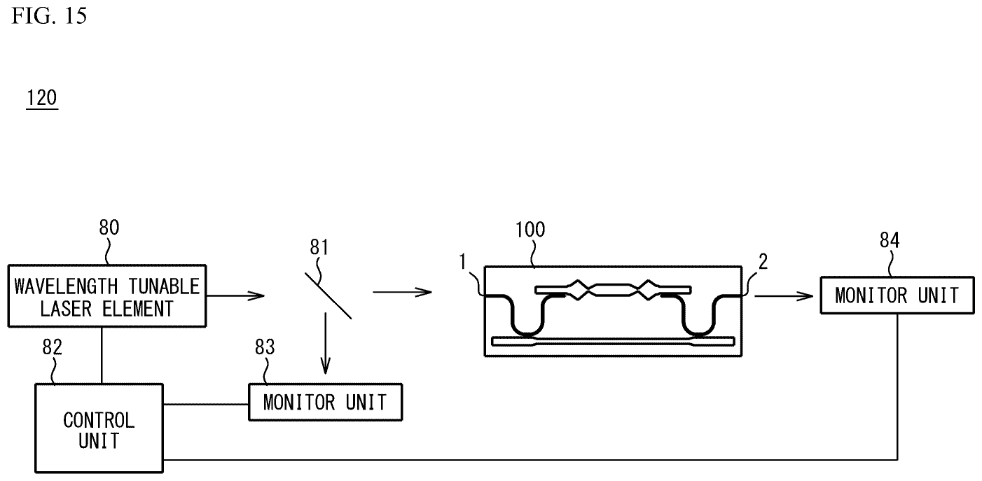

As an application example of optical filter 100, a wavelength locker 120 will be described. FIG. 15 is a diagram illustrating wavelength locker 120. Wavelength locker 120 has optical filter 100, a wavelength tunable laser element 80, a control unit 82, and monitor units 83 and 84.

Wavelength tunable laser element 80 is a light source and emits laser light. Control unit 82 controls the wavelength of the light emitted from wavelength tunable laser element 80. The light emitted from wavelength tunable laser element 80 is split by a beam splitter 81. One of the branched lights is incident on monitor unit 83. Monitor unit 83 detects the intensity of incident light.

The other of the branched lights is incident om entry port 1 of optical filter 100. The light emitted from exit port 2 of optical filter 100 enters monitor unit 84. Monitor unit 84 detects the intensity of light. Control unit 82 acquires the intensity of light detected by monitor unit 83 and the intensity of light detected by monitor unit 84. Control unit 82 calculates the transmittance of optical filter 100 based on these intensities.

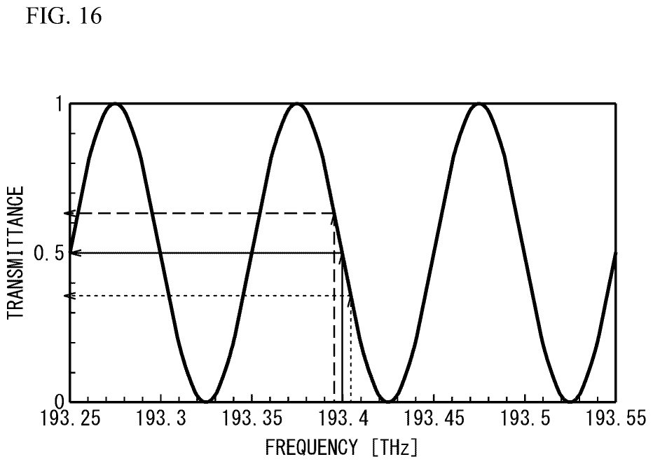

FIG. 16 is a diagram illustrating transmittance. The horizontal axis represents the frequency of light. The vertical axis represents the transmittance of optical filter 100. When the intensity of the light emitted from optical filter 100 changes, the transmittance also changes. The characteristics of optical filter 100 are stable against temperature changes. On the other hand, the wavelength of the light emitted from wavelength tunable laser element 80 may change due to a change in temperature or the like. When the wavelength of the light emitted from wavelength tunable laser element 80 changes, the intensity of the light emitted from optical filter 100 changes, and the transmittance also changes.

For example, the target value of the transmittance is set to 0.5. The frequency corresponding to the transmittance of 0.5 is 193.4 THz. If the frequency is higher than 193.4 THz, the transmittance will be higher than 0.5. If the frequency is lower than 193.4 THz, the transmittance will be lower than 0.5. Control unit 82 changes the oscillation wavelength of wavelength tunable laser element 80 so that the transmittance is 0.5. The oscillation wavelength is maintained at a desired value.

According to the embodiment, mutually different modes propagate through three or more sections of optical filter 100. As illustrated in FIGS. 4A and 4B, the temperature dependency of the spectrum can be reduced by appropriately setting the waveguide length. As illustrated in FIGS. 14A and 14B, the section length in the embodiment is shorter than that in the comparative example in which two modes are propagated. Since the section length is reduced, the waveguide length can also be reduced. Both the temperature dependency and the waveguide length can be suppressed. Optical filter 100 can be miniaturized, and the change in the spectrum with respect to the temperature can be reduced.

As illustrated in FIG. 1, optical filter 100 has waveguides 20, 22, 24, and 26, and directional couplers 28, 30, 32, and 34. Waveguide 20 has section 21. Waveguide 22 has section 23. Waveguide 24 has section 25. Waveguide 26 has section 27. In directional coupler 28 and directional coupler 30, optical transition and mode conversion are performed. The TE0 mode propagates through section 21 of waveguide 20 and section 27 of waveguide 26. The TE1 mode propagates through section 23 of waveguide 22. The TM0 mode propagates through section 25 of waveguide 24. Three modes propagate through optical filter 100. As illustrated in FIGS. 14A and 14B, the section length can be shortened according to the embodiment as compared with the comparative example. Both the temperature dependency and the waveguide length can be suppressed.

As illustrated in FIGS. 6A and 6B, the length of each of the sections is designed in the manufacturing process of optical filter 100. The section length is designed based on the propagation constant in the section and the amount of change in phase of light. An optimum section length is designed and a waveguide having the section length is manufactured. By propagating different modes through three or more sections, the temperature dependency of the spectrum can be reduced. Since the section length is shorter than that of the comparative example, the waveguide length can be suppressed.

The section length is designed in accordance with equation 2. In equation 2, the matrix A on the left side includes the propagation constant. The column vector on the left side includes section lengths L1 to Ln. The first term on the right side includes the wavelength λ and FSR. The second term on the right side includes the phase change amount φ. By using equation 2, section lengths L1 to Ln can be calculated. Both the temperature dependency and the waveguide length can be suppressed.

By determining the width of the section, the propagation constant βn is determined, and the terms in the matrix A are calculated. Section lengths L1 to Ln are calculated corresponding to width using equation 2. As illustrated in FIGS. 7A and 7B, the waveguide is manufactured by etching silicon layer 16a. When the width is small, it is difficult to manufacture the waveguide. The larger the width, the easier the manufacturing. For example, the width is swept, and the section length for each width is calculated. A value of width that is easy to manufacture is selected, and a section length corresponding to the width is adopted. Silicon layer 16a is etched to manufacture a waveguide having the width and the section length. The optical filter is easy to manufacture, and waveguide length and temperature dependency can be also suppressed.

When sweeping the width and searching for the appropriate section length, the correction term (the second term on the right side in equation 2) may be calculated for all of the swept widths. In order to reduce the amount of calculation, the correction term may not be calculated for all the swept widths, but only a part of the correction terms may be calculated. For the width to be swept, the section length without considering the correction term is calculated. For example, a set of small values among the calculated section lengths is set as a candidate of the section length. A correction term corresponding to the candidate of the section length is calculated, and the section length is calculated by the correction term and the candidate (FIG. 6B).

The matrix A corresponding to the assumed width candidate may be calculated in advance and stored in control unit 50. The wavelength of the light propagating through optical filter 100 and FSR of the spectrum may be determined, and column vector B may be calculated in advance and stored in control unit 50. The section length is proportional to the square of the wavelength λ and inversely proportional to FSR. FSR may be, for example, 1 nm or less. The spectrum has periodic peaks as in the example of FIG. 4A. By designing the section length appropriately, the section length and the temperature dependency can be suppressed.

At least one of the plurality of waveguides has a polarization rotator. The polarization rotator converts the mode of light and propagates the mode through the waveguide. As illustrated in FIGS. 1 and 2C, waveguide 24 has polarization rotator 36 and polarization rotator 38. In polarization rotator 36, the mode of the light is converted from the TE1 mode to the TM0 mode. In polarization rotator 38, the mode of the light is converted from the TM0 mode to the TE1 mode. Mode conversion is performed in one waveguide 24, and the TM0 mode can be propagated through section 25. Since the three modes propagate through optical filter 100, both the temperature dependency and the waveguide length can be suppressed.

As illustrated in FIG. 3A, the waveguide includes waveguide core 16. As illustrated in FIGS. 2D and 3B, each of polarization rotators 36 and 38 has the tapered shape and includes waveguide core 16 and rib portions 17. The waveguide and the polarization rotator can be manufactured by processing a Si layer by etching or the like.

As illustrated in FIGS. 2D and 3B, the polarization rotator includes waveguide core 16 and rib portions 17. The planar shape of the polarization rotator is a tapered shape. As illustrated in FIG. 2B, each of sections 41 and 42 of waveguide 22 has the tapered shape. The phase is likely to change in these portions. As in the examples of equations 6 and 8, a difference of about several percent occurs between the section length including the correction term C in the calculation and the section length not including the correction term C. The section length can be calculated with high accuracy by considering the correction term C including the phase change amount φ.

Optical filter 100 propagates three modes. The n in equation 2 is determined according to the number of sections. In optical filter 100, three section lengths L1, L2, and L3 are designed. In equation 2, n=3, and the design in accordance with equation 3 may be performed. The number of modes may be four or more, and the number of sections is changed according to the number of modes. When the number of section lengths to be calculated is four or more, the n is four or more in equation 2. The section length can be calculated by multiplying a general inverse matrix A⁻¹ of the matrix A from the left of equation 2.

Optical filter 100 may be formed on an SOI substrate or may be formed on a component other than an SOI substrate. The waveguide may include waveguide core 16 formed of Si or may be formed of other materials. The polarization rotator may have a configuration other than that of FIG. 2D.

The functions described above can be enabled by a computer. In this case, a program describing the processing contents of the functions that the processing apparatus should have is provided. The program is executed by the computer, and thus the processing functions are enabled on the computer. The program describing the processing contents can be recorded in a computer-readable storage medium (excluding carriers).

When the program is distributed, the program is sold in the form of a portable storage medium such as a digital versatile disc (DVD) or a compact disc read only memory (CD-ROM) on which the program is recorded. Alternatively, the program may be stored in a storage device of a server computer, and the program may be transferred from the server computer to another computer via a network.

A computer that executes a program stores, for example, the program recorded in a portable storage medium or the program transferred from a server computer in its own storage device. Then, the computer reads the program from the storage device of the computer and executes processing according to the program. The computer may read the program directly from the portable storage medium and execute the processing according to the program. Further, the computer can also execute processing in accordance with the received program each time the program is transferred from the server computer.

Although the embodiments of the present disclosure have been described in detail, the present disclosure is not limited to the specific embodiments, and various modifications and changes can be made within the scope of the gist of the present disclosure described in the claims.

In addition to the description of the embodiments, the following appendices are further disclosed.

### Appendix 1

An optical filter including:
three or more waveguides; and
a plurality of sections provided in the three or more waveguides, respectively, wherein
modes of light propagating through the sections of the three or more waveguides are different from each other.

### Appendix 2

The optical filter according to Appendix 1, wherein at least one of the three or more waveguides has a polarization rotator.

### Appendix 3

The optical filter according to Appendix 2, wherein
the three or more waveguides include a waveguide core, and
the polarization rotator includes the waveguide core and a rib portion protruding from the waveguide core.

### Appendix 4

The optical filter according to Appendix 2 or 3, wherein
the three or more waveguides include a first waveguide, a second waveguide, a third waveguide, and a fourth waveguide,
the sections include a first section, a second section, a third section, and a fourth section,
the polarization rotator includes a first polarization rotator and a second polarization rotator,
the first waveguide is optically coupled to the second waveguide in a first coupling portion and is optically coupled to the third waveguide in a second coupling portion behind the first coupling portion, the first waveguide having the first section between the first coupling portion and the second coupling portion,
the second waveguide is optically coupled to the fourth waveguide in a third coupling portion behind the first coupling portion, the second waveguide having the second section between the first coupling portion and the third coupling portion,
the third waveguide is optically coupled to a portion of the fourth waveguide in front of the third coupling portion in a fourth coupling portion behind the second coupling portion, the third waveguide having the third section between the second coupling portion and the fourth coupling portion,
the third waveguide has the first polarization rotator and the second polarization rotator,
the first polarization rotator is located between the second coupling portion and the fourth coupling portion,
the second polarization rotator is located between the first polarization rotator and the fourth coupling portion,
the third section is located between the first polarization rotator and the second polarization rotator,
the fourth waveguide has the fourth section between the third coupling portion and the fourth coupling portion, and
a mode of light propagating through the first section and the fourth section, a mode of light propagating through the second section, and a mode of light propagating through the third section are different from each other.

### Appendix 5

The optical filter according to Appendix 4, wherein
a TE0 mode propagates in the first section and the fourth section,
a TE1 mode propagates in the second section, and
a TM0 mode propagates in the third section.

### Appendix 6

A method of manufacturing an optical filter,
the optical filter including three or more waveguides,
the three or more waveguides having a plurality of sections, respectively,
modes of light propagating through the sections of the three or more waveguides being different from each other,
each of the sections having a length corresponding to a propagation constant in a corresponding section and an amount of change in phase of light in the three or more waveguides, the method comprising:
forming the three or more waveguides having the sections.

### Appendix 7

The method of manufacturing an optical filter according to Appendix 6, including:
designing the lengths of the sections; and
forming the three or more waveguides based on the lengths of the sections, wherein
the designing of the lengths of the sections includes designing the lengths of the sections in accordance with equation 1.

### Appendix 8

The method of manufacturing an optical filter according to Appendix 7, wherein the designing of the lengths of the sections includes determining widths of the sections to calculate terms of a matrix given in the equation 1.

### Appendix 9

The method of manufacturing an optical filter according to Appendix 7 or 8, wherein
the three or more waveguides include a first waveguide, a second waveguide, a third waveguide, and a fourth waveguide,
the sections include a first section, a second section, a third section, and a fourth section,
the first waveguide has the first section,
the second waveguide has the second section,
the third waveguide has the third section,
the fourth waveguide has the fourth section,
a mode of light propagating through the first section and the fourth section, a mode of light propagating through the second section, and a mode of light propagating through the third section are different from each other, and
the designing of the lengths of the sections designs a total length of the first section and the fourth section, a length of the second section, and a length of the third section.

### Appendix 10

A method of designing an optical filter,
the optical filter including three or more waveguides,
the three or more waveguides having a plurality of sections, respectively,
modes of light propagating through the sections of the three or more waveguides being different from each other,
the method comprising:
designing a length of each of the sections based on a propagation constant in a corresponding section and an amount of change in phase of light in the three or more waveguides.

### Appendix 11

The method of designing an optical filter according to Appendix 10, wherein the length of each of the sections is designed in accordance with equation 1.

### Appendix 12

The method of designing an optical filter according to Appendix 11, including:
determining a width of each of the sections to calculate terms of a matrix given in the equation 1; and
designing the length of each of the sections in accordance with the equation 1.

### Appendix 13

The method of designing an optical filter according to any one of Appendices 10 to 12, wherein
the three or more waveguides include a first waveguide, a second waveguide, a third waveguide, and a fourth waveguide,
the sections include a first section, a second section, a third section, and a fourth section,
the first waveguide has the first section,
the second waveguide has the second section,
the third waveguide has the third section,
the fourth waveguide has the fourth section,
a mode of light propagating through the first section and the fourth section, a mode of light propagating through the second section, and a mode of light propagating through the third section are different from each other, and
a total length of the first section and the fourth section, a length of the second section, and a length of the third section are designed.

### Appendix 14

A design apparatus for designing an optical filter,
the optical filter including three or more waveguides,
the three or more waveguides having a plurality of sections, respectively,
modes of light propagating through the sections of the three or more waveguides being different from each other,
the design apparatus including:
a first calculator configured to calculate propagation constants in the sections;
a second calculator configured to calculate an amount of change in phase of light in the three or more waveguides; and
a third calculator configured to calculate lengths of the sections, based on the propagation constants and the amount of change in phase.

### Appendix 15

The design apparatus for designing an optical filter according to Appendix 14, wherein the third calculator is configured to calculate the lengths of the sections in accordance with equation 1.

### Appendix 16

The design apparatus for designing an optical filter according to Appendix 15, wherein the calculator is configured to calculate terms of a matrix given in the equation 1, based on widths of the sections.

### Appendix 17

The design apparatus for designing an optical filter according to any one of Appendices 14 to 16, wherein
the three or more waveguides include a first waveguide, a second waveguide, a third waveguide, and a fourth waveguide,
the sections include a first section, a second section, a third section, and a fourth section,
the first waveguide has the first section,
the second waveguide has the second section,
the third waveguide has the third section,
the fourth waveguide has the fourth section,
a mode of light propagating through the first section and the fourth section, a mode of light propagating through the second section, and a mode of light propagating through the third section are different from each other, and
the third calculator is configured to calculate a total length of the first section and the fourth section, a length of the second section, and a length of the third section.

### Appendix 18

A non-transitory computer-readable recording medium having stored therein a program for designing an optical filter for causing a computer to execute a process,
the optical filter including three or more waveguides,
the three or more waveguides having a plurality of sections, respectively,
modes of light propagating through the sections of the three or more waveguides being different from each other,
the process comprising:
calculating propagation constants in the sections;
calculating an amount of change in phase of light in the three or more waveguides; and
calculating lengths of the sections, based on the propagation constants and the amount of change in phase.

### Appendix 19

The non-transitory computer-readable recording medium according to Appendix 18, wherein the calculating lengths of the sections calculates the lengths of the sections in accordance with equation 1.

### Appendix 20

The non-transitory computer-readable recording medium according to Appendix 19, wherein the calculating propagation constants calculates terms of a matrix given in the equation 1, based on widths of the sections.

### Appendix 21

The non-transitory computer-readable recording medium according to any one of Appendices 18 to 20, wherein
the three or more waveguides include a first waveguide, a second waveguide, a third waveguide, and a fourth waveguide,
the sections include a first section, a second section, a third section, and a fourth section,
the first waveguide has the first section,
the second waveguide has the second section,
the third waveguide has the third section,
the fourth waveguide has the fourth section,
a mode of light propagating through the first section and the fourth section, a mode of light propagating through the second section, and a mode of light propagating through the third section are different from each other, and
the calculating lengths of the sections calculates a total length of the first section and the fourth section, a length of the second section, and a length of the third section.

What is claimed is:

1. An optical filter comprising:
three or more waveguides; and
a plurality of sections provided in the three or more waveguides, respectively, wherein
modes of light propagating through the sections of the three or more waveguides are different from each other.

2. The optical filter according to claim 1, wherein at least one of the three or more waveguides has a polarization rotator.

3. The optical filter according to claim 2, wherein
the three or more waveguides include a waveguide core, and
the polarization rotator includes the waveguide core and a rib portion protruding from the waveguide core.

4. The optical filter according to claim 2, wherein
the three or more waveguides include a first waveguide, a second waveguide, a third waveguide, and a fourth waveguide,
the sections include a first section, a second section, a third section, and a fourth section,
the polarization rotator includes a first polarization rotator and a second polarization rotator,
the first waveguide is optically coupled to the second waveguide in a first coupling portion and is optically coupled to the third waveguide in a second coupling portion behind the first coupling portion, the first waveguide having the first section between the first coupling portion and the second coupling portion,
the second waveguide is optically coupled to the fourth waveguide in a third coupling portion behind the first coupling portion, the second waveguide having the second section between the first coupling portion and the third coupling portion,
the third waveguide is optically coupled to a portion of the fourth waveguide in front of the third coupling portion in a fourth coupling portion behind the second coupling portion, the third waveguide having the third section between the second coupling portion and the fourth coupling portion,
the third waveguide has the first polarization rotator and the second polarization rotator,
the first polarization rotator is located between the second coupling portion and the fourth coupling portion,
the second polarization rotator is located between the first polarization rotator and the fourth coupling portion,
the third section is located between the first polarization rotator and the second polarization rotator,
the fourth waveguide has the fourth section between the third coupling portion and the fourth coupling portion, and
a mode of light propagating through the first section and the fourth section, a mode of light propagating through the second section, and a mode of light propagating through the third section are different from each other.

5. The optical filter according to claim 4, wherein
a TE0 mode propagates in the first section and the fourth section,
a TE1 mode propagates in the second section, and
a TM0 mode propagates in the third section.

6. A method of manufacturing an optical filter,
the optical filter including three or more waveguides,
the three or more waveguides having a plurality of sections, respectively,
modes of light propagating through the sections of the three or more waveguides being different from each other,
each of the sections having a length corresponding to a propagation constant in a corresponding section and an amount of change in phase of light in the three or more waveguides, the method comprising:
forming the three or more waveguides having the sections.

7. The method of manufacturing an optical filter according to claim 6, comprising:
designing the lengths of the sections; and
forming the three or more waveguides based on the lengths of the sections, wherein
the designing of the lengths of the sections includes designing the lengths of the sections in accordance with equation 1:
$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k}\end{matrix} ) ( \begin{matrix}L 1 \\ ⋮ \\ L n\end{matrix} ) = ( \begin{matrix}0 \\ 0 \\ \frac{{λ}^{2}}{FSR}\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k}\end{matrix} )$$
where
L1 to Ln denote the lengths of the sections,
β1 to βn denote the propagation constants for the sections,
T denotes a temperature,
λ denotes a wavelength,
k denotes a wave number,
FSR denotes an interval between peaks of a spectrum, and
φ denotes the amount of change in phase.

8. The method of manufacturing an optical filter according to claim 7, wherein the designing of the lengths of the sections includes determining widths of the sections to calculate terms of a matrix given in the equation 1.

9. The method of manufacturing an optical filter according to claim 7, wherein
the three or more waveguides include a first waveguide, a second waveguide, a third waveguide, and a fourth waveguide,
the sections include a first section, a second section, a third section, and a fourth section,
the first waveguide has the first section,
the second waveguide has the second section,
the third waveguide has the third section,
the fourth waveguide has the fourth section,
a mode of light propagating through the first section and the fourth section, a mode of light propagating through the second section, and a mode of light propagating through the third section are different from each other, and
the designing of the lengths of the sections designs a total length of the first section and the fourth section, a length of the second section, and a length of the third section.

10. A method of designing an optical filter,
the optical filter including three or more waveguides,
the three or more waveguides having a plurality of sections, respectively,
modes of light propagating through the sections of the three or more waveguides being different from each other,
the method comprising:
designing a length of each of the sections based on a propagation constant in a corresponding section and an amount of change in phase of light in the three or more waveguides.

11. A design apparatus for designing an optical filter,
the optical filter including three or more waveguides,
the three or more waveguides having a plurality of sections, respectively,
modes of light propagating through the sections of the three or more waveguides being different from each other,
the design apparatus comprising:
a first calculator configured to calculate propagation constants in the sections;
a second calculator configured to calculate an amount of change in phase of light in the three or more waveguides; and
a third calculator configured to calculate lengths of the sections, based on the propagation constants and the amount of change in phase.

12. A non-transitory computer-readable recording medium having stored therein a program for designing an optical filter for causing a computer to execute a process,
the optical filter including three or more waveguides,
the three or more waveguides having a plurality of sections, respectively,
modes of light propagating through the sections of the three or more waveguides being different from each other,
the process comprising:
calculating propagation constants in the sections;
calculating an amount of change in phase of light in the three or more waveguides; and
calculating lengths of the sections, based on the propagation constants and the amount of change in phase.
